(19) United States
(12) Patent Application Publication
(10) Pub. No.: US 2026/0169861 A1
(43) Pub. Date: Jun. 18, 2026

(54) MODEL TRAINING SNAPSHOT BACKUP METHOD AND MODEL TRAINING SNAPSHOT MIGRATE METHOD

(71) Applicant: BEIJING BAIDU NETCOM SCIENCE TECHNOLOGY CO., LTD., Beijing (CN)

(72) Inventors: Gexiao Tian, Beijing (CN); Weibao Gong, Beijing (CN); Jinle Zeng, Beijing (CN); Li Yu, Beijing (CN); Zhenhua Wang, Beijing (CN); Zhaogeng Li, Beijing (CN); Dong Li, Beijing (CN); Dianhai Yu, Beijing (CN); Haifeng Wang, Beijing (CN)

(73) Assignee: BEIJING BAIDU NETCOM SCIENCE TECHNOLOGY CO., LTD., Beijing (CN)

(21) Appl. No.: 19/387,018

(22) Filed: Nov. 12, 2025

(30) Foreign Application Priority Data
Dec. 16, 2024 (CN) 202411855824.7

(51) Int. Cl. G06F 11/14

(52) U.S. Cl. CPC G06F 11/1446; G06F 2201/84

(57) ABSTRACT

A model training snapshot backup method, performed by a first training node, is provided. The method includes: obtaining dynamic parameters to be backed up of a current training step of a model; determining a training snapshot of the current training step according to the dynamic parameters to be backed up; and backing up the training snapshot to a memory of the first training node.

### CROSS-REFERENCE TO RELATED APPLICATION

The present application claims priority to and benefits of Chinese Patent Application Serial No. 2024118558247, filed on Dec. 16, 2024, the entire content of which is incorporated herein by reference.

### TECHNICAL FIELD

The disclosure relates to the field of computer technologies, in particular to deep learning and artificial intelligence technologies, especially to a model training snapshot backup method and a model training snapshot migrate method.

### BACKGROUND

In related arts, according to a model training snapshot backup method, training snapshot backup is implemented in two stages, namely, Device to Host (D2H) synchronization and persistence asynchronization. However, a large number of operations in the above training snapshot backup method are performed simultaneously, which often affects a training performance of the model and prolongs a training interruption time.

### SUMMARY

According to a first aspect of the disclosure, a model training snapshot backup method is provided. The method is performed by a first training node, and includes: obtaining dynamic parameters to be backed up of a current training step of a model; determining a training snapshot of the current training step according to the dynamic parameters to be backed up; and backing up the training snapshot to a memory of the first training node.

According to a second aspect of the disclosure, a model training snapshot migrate method is provided. The method is performed by a first training node, and includes: in response to identifying a fault in the first training node, determining a target training snapshot to be migrated in a memory of the first training node; and migrating the target training snapshot to a memory of a scheduled second training node.

According to a third aspect of the disclosure, a model training snapshot migrate method is provided. The method is performed by a second training node, and includes: receiving a target training snapshot migrated from a failed first training node, in which the target training snapshot is stored in a memory of the first training node; and storing the target training snapshot in a memory of the second training node.

According to a fourth aspect of the disclosure, an electronic device is provided. The electronic device includes: at least one processor and a memory communicatively connected to the at least one processor. The memory stores instructions executable by the at least one processor, and when the instructions are executed by the at least one processor, the at least one processor is caused to execute the model training snapshot backup method described in the first aspect, the model training snapshot migrate method described in the second aspect or the model training snapshot migrate method described in the third aspect of the disclosure.

According to a fifth aspect of the disclosure, a non-transitory computer readable storage medium is provided. The medium stores computer instructions that are used to cause a computer to execute the model training snapshot backup method described in the first aspect, the model training snapshot migrate method described in the second aspect or the model training snapshot migrate method described in the third aspect of the disclosure.

### BRIEF DESCRIPTION OF THE DRAWINGS

The accompanying drawings are used for better understanding the solution of the disclosure and do not constitute as a limitation on the disclosure, in which:

FIG. 1 is a schematic flowchart of a model training snapshot backup method according to an embodiment of the disclosure.

FIG. 2 is a schematic flowchart of a model training snapshot backup method according to an embodiment of the disclosure.

FIG. 3 is a schematic flowchart of a model training snapshot backup method according to an embodiment of the disclosure.

FIG. 4 is a schematic flowchart of a model training snapshot migrate method according to an embodiment of the disclosure.

FIG. 5 is a schematic flowchart of a model training snapshot migrate method according to an embodiment of the disclosure.

FIG. 6 is a schematic flowchart of a model training snapshot migrate method according to an embodiment of the disclosure.

FIG. 7 is a schematic diagram of a model training snapshot backup apparatus according to an embodiment of the disclosure.

FIG. 8 is a schematic diagram of a model training snapshot migrate apparatus according to an embodiment of the disclosure.

FIG. 9 is a schematic diagram of a model training snapshot migrate apparatus according to an embodiment of the disclosure.

FIG. 10 is a schematic block diagram of an electronic device according to an embodiment of the disclosure.

### DETAILED DESCRIPTION

Example embodiments of the disclosure are described below with reference to the accompanying drawings, in which various details of the embodiments of the disclosure are included to facilitate understanding, and they should be considered as exemplary only. Therefore, those skilled in the art should realize that various changes and modifications can be made to the embodiments described herein without departing from the scope and spirit of the disclosure. For clarity and brief, well-known functions and structures are omitted in the following descriptions.

The technical fields involved in the schemes of the disclosure are briefly described below.

Computer technology is wide-ranging and can be roughly categorized into computer system technology, computer device technology, computer component technology and computer assembly technology and other technologies. Computer technology includes: basic principles of computational methods and designs of computing units, instruction systems, Central Processing Unit (CPU) designs, pipeline principles and their application in CPU designs, storage systems, buses and input-output. Computer is a modern intelligent electronic device with data storage and modification functions, and can realize calculation of related logics and data, which integrates network, computing, media and other technologies. Computer technology refers to technical methods and technical means used in the field of computer, or refers to its hardware technology, software technology and application technology. Obviously, computer technology has obvious comprehensive characteristics and is rapidly evolving in close conjunction with electronic engineering, application physics, mechanical engineering, modern communication technology and mathematics, etc.

Artificial intelligence (AI) is a study that causes computers to simulate certain thought processes and intelligent behaviors (e.g., learning, reasoning, thinking, planning, etc.) of human beings, which includes techniques both at the hardware level and at the software level. AI hardware technology generally includes computer vision technology, speech recognition technology, natural language processing technology and learning/deep learning (DL), big data processing technology, knowledge graph technology and other major aspects.

DL is a new research direction in a field of machine learning (ML). DL has been introduced into ML to bring it closer to the original goal—AI. DL is a process of learning intrinsic laws and representation levels of sample data, and information gained from learning can be very helpful in interpreting data such as texts, images and sounds. The ultimate goal of DL is to enable machines to have analytical learning capabilities as humans and be able to recognize data such as texts, images and sounds. DL is a complex ML algorithm that has achieved results in speech and image recognition that far exceed previous related arts.

A mode training snapshot backup method and a mode training snapshot migrate method according to the embodiments of the disclosure are described with reference to the attached drawings.

FIG. 1 is a schematic flowchart of a model training snapshot backup method according to an embodiment of the disclosure. As illustrated in FIG. 1, the model training snapshot backup method proposed in the embodiment is performed by a first training node. The method includes the following steps.

At step S101, dynamic parameters to be backed up of a current training step of the model are obtained.

It should be noted that in response to a failure of a training task during a model training process, dynamic parameters of an unsaved training step cannot contribute effective calculation time, and will be repeatedly calculated in a case where the training task returns to normal, that is, repeated calculation overhead will be generated. Therefore, in the present disclosure, the dynamic parameters to be backed up of the current training step of the model can be obtained to implement subsequent training snapshot backup of the model, which minimizing the repeated calculation overhead of the model.

It should be noted that during the model training process, each training step of the model will generate a variety of dynamic parameters, and the dynamic parameters to be backed up of the current training step of the model can be determined based on the various dynamic parameters generated in the current training step of the model.

It should be noted that the type of dynamic parameters to be backed up of the current training step of the model is not limited by the disclosure, and can be selected according to actual situations.

In some embodiments, the dynamic parameters to be backed up of the current training step of the model may be model parameters. In some embodiments, the dynamic parameters to be backed up of the current training step of the model may be model parameters and a model training state.

For example, the model parameters may be weight values and offset values of each network layer in the model, and the model training state may be a current count of training steps of the model or a learning rate.

At step S102, a training snapshot of the current training step is determined according to the dynamic parameters to be backed up.

The training snapshot of the current training step refers to the record and preservation of the state of the current training step of the model during the model training process.

In the embodiments of the disclosure, after obtaining the dynamic parameters, the training snapshot of the current training step can be constructed according to the dynamic parameters.

In some embodiments, the dynamic parameters of the current training step may be summarized by type to determine the training snapshot of the current training step.

At step S103, the training snapshot is backed up to a memory of the first training node.

In the embodiments of the disclosure, a target backup process corresponding to the current training step can be determined, and the target backup process is executed to back up the training snapshot to the memory of the first training node. The target backup process is either a first backup process or a second backup process.

For example, in a case where the target backup process is the first backup process, a first training snapshot is obtained by performing a single backup for the dynamic parameters to be backed up, and the first training snapshot is written to a mount abstraction layer of the first training node. In a case where the target backup process is the second backup process, a first training snapshot and a second training snapshot are obtained by performing a duple backup for the dynamic parameters to be backed up, the first training snapshot is written to a mount abstraction layer of the first training node, and the second training snapshot is written into a remote storage cluster via a persistence medium of the first training node.

According to the model training snapshot backup method in the embodiments of the disclosure, the dynamic parameters to be backed up of the current training step of the model are obtained, so that the training snapshot of the current training step can be determined according to the dynamic parameters and backed up to the memory of the first training node. Therefore, by backing up the training snapshot to the memory of the first training node, the present disclosure can avoid affecting training performances, and enable the most efficient recovery when a fault occurs in a model training node, shorten training interruption time, significantly reduce the repeated calculation overhead, and improve a model training efficiency.

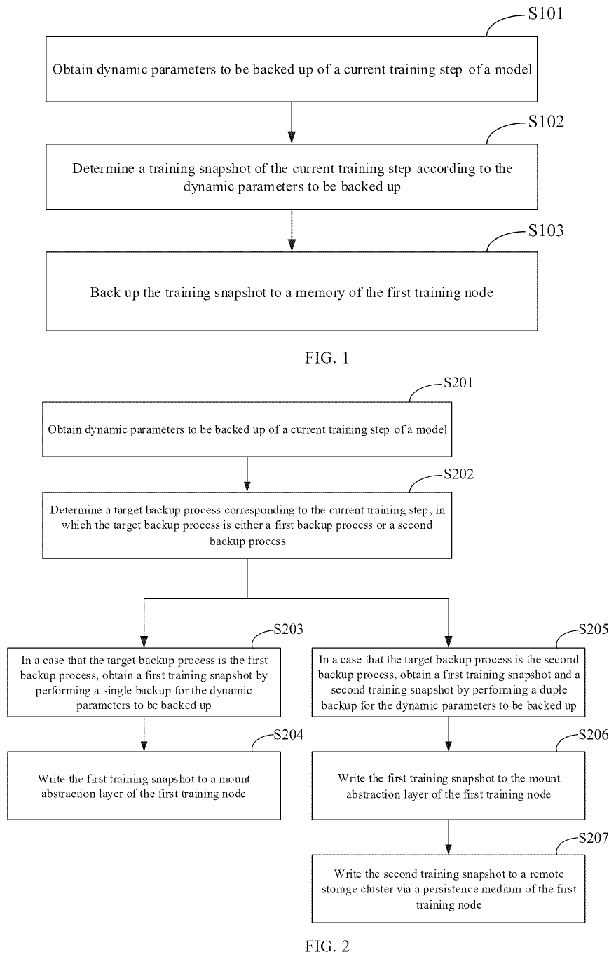

FIG. 2 is a schematic flowchart of another model training snapshot backup method according to an embodiment of the disclosure.

As illustrated in FIG. 2, the model training snapshot backup method proposed in the embodiment includes the following steps.

At step S201, dynamic parameters to be backed up of a current training step of a model are obtained.

Related contents of step S201 can refer to the above-mentioned embodiments, and the details will not be repeated here.

At step S202, a target backup process corresponding to the current training step is determined, in which the target backup process is either a first backup process or a second backup process.

The first backup process may be a Flash Checkpoint (FC), which backs up the training snapshots to the memory of the first training node by step for each training step.

The second backup process may be a Stable Checkpoint (SC), which backs up the training snapshots to the memory of the first training node every certain number of training steps.

The first backup process and the second backup process are compatible and complementary.

It should be noted that the specific way to determine the target backup process corresponding to the current training step is not limited by the disclosure, and can be selected according to actual situations.

In some embodiments, a preset training step interval of the second backup process may be obtained, and based on the preset training step interval, the training steps that need to adopt the second backup process are determined, while the remaining training steps adopt the first backup process.

For example, in the second backup process, if the training snapshot is backed up to the memory of the first training node every 50 training steps, the target backup process for the 1^{st}-49^{th} training steps is the first backup process, and the target backup process for the 50^{th} training step is the second backup process, and so on.

At step S203, in a case that the target backup process is the first backup process, a first training snapshot is obtained by performing a single backup for the dynamic parameters to be backed up.

In the embodiments of the disclosure, when it is determined that the target backup process corresponding to the current training step is the first backup process, the first training snapshot is obtained by performing the single backup for the dynamic parameters.

At step S204, the first training snapshot is written to a mount abstraction layer of the first training node.

It should be noted that the disclosure abstracts a layer of file system representation, i.e., the mount abstraction layer, so that the training snapshot (file) written to a specific memory block can be continuously accessed via a standard portable operating system interface of UNIX (POSIX). Moreover, the mount abstraction layer can also ensure that the training snapshot is in a state ready for migration.

In the embodiments of the disclosure, after obtaining the first training snapshot, the first training snapshot can be written to the mount abstraction layer of the first training node.

In the embodiments of the disclosure, in order to obtain the state of each step of the backup process more accurately, an exception monitoring can be performed on each step of the first backup process. In response to a failure of one of the steps, first indication information is sent to a fault tolerance platform. The first indication information indicates the fault tolerance platform to perform at least one of the following operations: labeling the first backup process of the current training step of the model as failed; or sending a first alarm message.

It should be noted that the first alarm message is not limited by the disclosure. In some embodiments, the first alarm message may be a text alarm message.

In the embodiments of the disclosure, after writing the first training snapshot to the mount abstraction layer of the first training node, third indication information is sent to the fault tolerance platform. The third indication information indicates the fault tolerance platform to perform at least one of the following operations: updating a first backup list corresponding to the first backup process; or clearing an expired first training snapshot and a second training snapshot corresponding to the expired first training snapshot.

At step S205, in a case that the target backup process is the second backup process, a first training snapshot and a second training snapshot are obtained by performing a duple backup for the dynamic parameters to be backed up.

In the embodiments of the disclosure, when it is determined that the target backup process corresponding to the current training step is the second backup process, the duple backup is performed for the dynamic parameters to obtain the first training snapshot and the second training snapshot.

At step S206, the first training snapshot is written to a mount abstraction layer of the first training node.

At step S207, the second training snapshot is written to a remote storage cluster via a persistence medium of the first training node.

In the embodiments of the disclosure, after obtaining the second training snapshot, the second training snapshot can be written to the persistence medium of the first training node and then written to the remote storage cluster via the persistence medium of the first training node.

In the embodiments of the disclosure, in order to obtain the state of each step of the backup process more accurately, an exception monitoring can be performed on each step of the second backup process. In response to a failure of one of the steps, at least one of the following operations is performed: exiting a training process; or sending second indication information to a fault tolerance platform, in which the second indication information indicates the fault tolerance platform to send a second alarm message.

It should be noted that the second alarm message is not limited by the disclosure. In some embodiments, the second alarm message may be a call alarm message.

In the embodiments of the disclosure, after writing the second training snapshot to the remote storage cluster, fourth indication information can be sent to the fault tolerance platform. The fourth indication information indicates the fault tolerance platform to perform at least one of the following operations: updating a second backup list corresponding to the second backup process; storing the second backup list to a remote server; or clearing an expired first training snapshot and a second training snapshot corresponding to the expired first training snapshot.

It should be noted that in the related arts, when backing up a training snapshot, a training snapshot backup process is often realized via a Vanilla Checkpoint (VC) backup process. The training snapshots in a training container are usually saved and backed up at a certain time interval. The backup process involves a large number of synchronous operations, which introduces time consumption. Moreover, in order to migrate the training snapshot when the training node failures, persistence of the backup process is realized via a disk and a back-end storage cluster. Via asynchronous modification, an upper limit of trigger frequency is limited by the time consumption overhead. Especially, when the back-end storage cluster uses a Transmission Control Protocol (TCP) service, the persistence of one training snapshot takes nearly 10 minutes. After the failed training node goes offline and a new normal-working training node goes online, the training process needs to pull the corresponding training snapshot from the back-end storage cluster via the platform for deployment, which increases introduces time consumption.

The specific process of the model training snapshot backup method of the embodiments of the disclosure will be explained below.

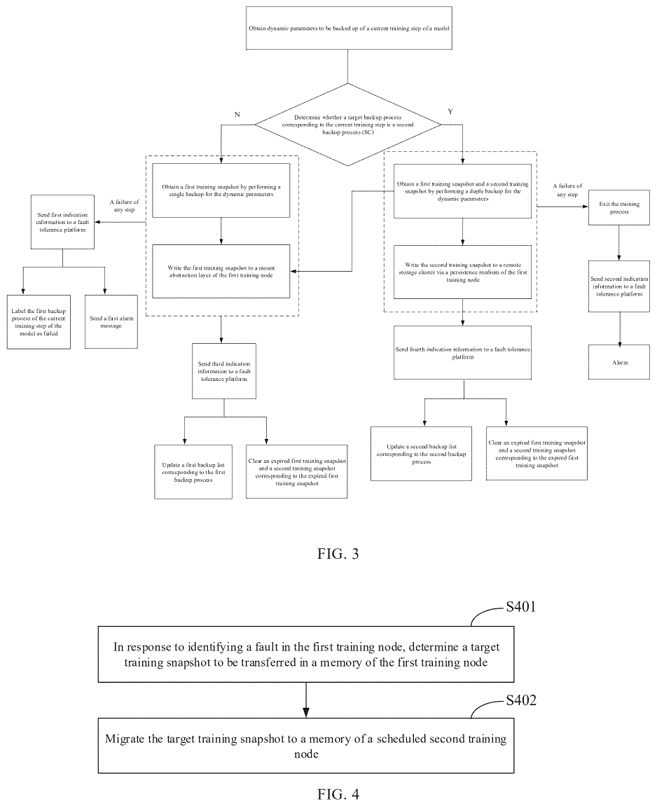

For example, as illustrated in FIG. 3, the dynamic parameters to be backed up of the current training step of the model are obtained, and it is determined whether the target backup process corresponding to the current training step is the second backup process (SC). If the target backup process corresponding to the current training step is the first backup process (FC) rather than the SC, the single backup is performed for the dynamic parameters to obtain the first training snapshot. The first training snapshot is written to the mount abstraction layer of the first training node. The exception monitoring is performed on each step of the FC, and in response to the failure of one step, the first indication information is sent to the fault tolerance platform. The first indication information indicates the fault tolerance platform to perform at least one of the following operations: labeling the FC of the current training step of the model as failed; or sending the first alarm message. After writing the first training snapshot to the mount abstraction layer of the first training node, the third indication information is sent to the fault tolerance platform. The third indication information indicates the fault tolerance platform to perform at least one of the following operations: updating the first backup list corresponding to the FC; or clearing the expired first training snapshot and the second training snapshot corresponding to the expired first training snapshot. If the target backup process corresponding to the current training step is the SC, the duple backup is performed for the dynamic parameters to obtain the first training snapshot and the second training snapshot. The first training snapshot is written to the mount abstraction layer of the first training node, and the second training snapshot is written to the remote storage cluster via the persistence medium of the first training node. The exception monitoring is performed on each step of the SC, and in response to the failure of one of steps, at least one of the following operations is performed: exiting the training process; or sending the second indication information to the fault tolerance platform, in which the second indication information indicates the fault tolerance platform to send the second alarm message. After writing the second training snapshot to the remote storage cluster, the fourth indication information is sent to the fault tolerance platform. The fourth indication information indicates the fault tolerance platform to perform at least one of the following operations: updating the second backup list corresponding to the SC; storing the second backup list to the remote server; or clearing the expired first training snapshot and the second training snapshot corresponding to the expired first training snapshot.

In conclusion, according to the model training snapshot backup method in the embodiments of the disclosure, the dynamic parameters to be backed up of the current training step of the model is obtained, and the target backup process corresponding to the current training step is determined. The target backup process is either the first backup process or the second backup process. If the target backup process is the first backup process, the first training snapshot is obtained by performing the single backup for the dynamic parameters, and the first training snapshot is written to the mount abstraction layer of the first training node. If the target backup process is the second backup process, the first training snapshot and the second training snapshot are obtained by performing the duple backup for the dynamic parameters. The first training snapshot is written to the mount abstraction layer of the first training node, and the second training snapshot is written to the remote storage cluster via the persistence medium of the first training node. Therefore, by asynchronously setting of the first backup process and the second backup process, the present disclosure can improve an efficiency of training snapshot backup, which avoids an impact of training snapshot backup on model training performances, enables the most efficient recovery when a fault occurs in the model training node, shortens the training interruption time, significantly reduces the repeated calculation overhead, and improves a model training efficiency.

FIG. 4 is a schematic flowchart of a model training snapshot migrate method according to an embodiment of the disclosure. As illustrated in FIG. 4, the model training snapshot migrate method proposed in the embodiment is performed by a first training node, and includes the following steps.

At step S401, in response to identifying a fault in the first training node, a target training snapshot to be migrated in a memory of the first training node is determined.

In the embodiments of the disclosure, during a model training process, fault identification can be performed on the first training node, and in response to identifying a fault in the first training node, the target training snapshot to be migrated in the memory of the first training node is determined.

At step S402, the target training snapshot is migrated to a memory of a scheduled second training node.

It should be noted that in a distributed training scenario, when a fault is identified in the first training node, in order to ensure a continuity of training and reduce repeated calculation overhead, the target training snapshot to be migrated in the memory of the first training node can be determined, and the target training snapshot can be migrated to the memory of the scheduled second training node (a normal available training node).

In the embodiments of the disclosure, in response to identifying a fault in the first training node, an exception indication is sent to a fault tolerance platform. The exception indication indicates the fault tolerance platform to send a node scheduling indication to a scheduling server, and the node scheduling indication indicates the scheduling server to schedule the second training node from available training nodes and wake up the second training node.

In the embodiments of the disclosure, the target training snapshot stored in a mount abstraction layer of the first training node is migrated to a mount abstraction layer of the second training node via a memory service container.

It should be noted that the disclosure provides a servicer that can be deployed on a training cluster, i.e., a memory service container. The memory service container enables the training node to make full use of a network bandwidth of Remote Direct Memory Access (RDMA). When scheduling the second training node from the available training nodes, it enables to migrate the target training snapshot stored in the mount abstraction layer at a high speed, i.e., migrating the target training snapshot to the mount abstraction layer of the second training node via the memory service container. Migrate time can be completely covered by the scheduling time of the second training node, thus minimizing a cost of migrating the training snapshot.

In the embodiments of the disclosure, the target training snapshot stored in the mount abstraction layer can be encoded to obtain a continuous memory space, and the continuous memory space is sent to a second memory service container in the second training node via a first memory service container in the first training node.

It should be noted that by encoding the target training snapshot stored in the mount abstraction layer, the continuous memory space (or can be referred as a buffer) is obtained. The network parameters of the first memory service container are configured, that is, a high-rate network transmission is initialized for the first memory service container, and security verification is performed on the target training snapshot. After the security verification is passed, the continuous memory space is sent to the second memory service container based on the configured network parameters.

In some embodiments, an integrity of the target training snapshot can be verified by a hash algorithm (Message Digest Algorithm 5, MD5) to implement the security verification of the target training snapshot.

In the embodiments of the disclosure, in order to obtain the state of each step of the migrate process more accurately, the migrate process of the target training snapshot can be monitored. In response to an exception, fifth indication information is sent to the fault tolerance platform. The fifth indication information indicates the fault tolerance platform to send an alarm message.

In the embodiments of the disclosure, in order to obtain the state of each step of the migrate process more accurately, the migrate process of the target training snapshot can be monitored. In response to an exception, relevant information of the second training node in the mount abstraction layer is cleared.

In conclusion, according to the model training snapshot migrate method in the embodiments of the disclosure, in response to identifying a fault in the first training node, the target training snapshot to be migrated in the memory of the first training node is determined and migrated to the memory of the scheduled second training node. Therefore, the disclosure shortens the migrate time of the model training snapshot, reduces a migrate cost of the model training snapshot, significantly improves a migrate efficiency of the model training snapshot, and reduces an interruption time of model training, thus improving a model training efficiency.

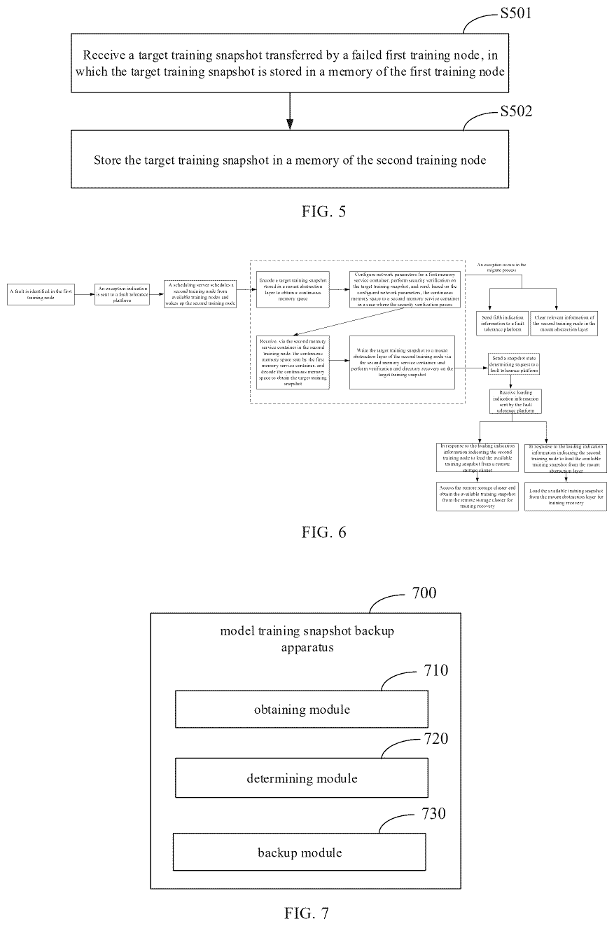

FIG. 5 is a schematic flowchart of a model training snapshot migrate method according to an embodiment of the disclosure.

As illustrated in FIG. 5, the model training snapshot migrate method proposed in the embodiment is performed by a second training node, and includes the following steps.

At step S501, a target training snapshot migrated from a failed first training node is received, in which the target training snapshot is stored in a memory of the first training node.

In the embodiments of the disclosure, the target training snapshot is migrated to a memory of a scheduled second training node via the first training node. Correspondingly, the second training node receives the target training snapshot migrated from the failed first training node.

At step S502, the target training snapshot is stored in a memory of the second training node.

In the embodiments of the disclosure, the target training snapshot sent by a first memory service container of the first training node via a second memory service container in the second training node, and the target training snapshot is written into a mount abstraction layer of the second training node via the second memory service container.

In some embodiments, a continuous memory space sent by the first memory service container is received via the second memory service container in the second training node, and the continuous memory space is decoded to obtain the target training snapshot. The continuous memory space is obtained by encoding the target training snapshot by the first memory service container.

In the embodiments of the disclosure, after the target training snapshot is obtained, verification and directory recovery can be performed on the target training snapshot.

In the embodiments of the disclosure, a snapshot state awareness request to a fault tolerance platform. The snapshot state awareness request is used to request the fault tolerance platform to determine whether there is an available training snapshot in the target training snapshot. Loading indication information sent by the fault tolerance platform is received, and the available training snapshot is loaded for training recovery according to the loading indication information.

In some embodiments, in response to the loading indication information indicating the second training node to load the available training snapshot (SC backup) from a remote storage cluster, the remote storage cluster is accessed and the available training snapshot is obtained from the remote storage cluster for the training recovery.

In some embodiments, in response to the loading indication information indicating the second training node to load the available training snapshot (FC backup) from the mount abstraction layer, the available training snapshot is loaded from the mount abstraction layer for the training recovery.

According to the model training snapshot migrate method in the embodiments of the disclosure, the target training snapshot migrated from the failed first training node is received, in which the target training snapshot is stored in the memory of the first training node. The target training snapshot is then stored in the memory of the second training node. Therefore, the disclosure shortens the migrate time of the model training snapshot, reduces a migrate cost of the model training snapshot, significantly improves a migrate efficiency of the model training snapshot, and reduces an interruption time of model training, thus improving a model training efficiency.

The specific process of the model training snapshot migrate method of the embodiments of the disclosure will be explained below.

For example, as illustrated in FIG. 6, in response to identifying a fault in the first training node, the exception indication is sent to the fault tolerance platform. The exception indication indicates the fault tolerance platform to send the node scheduling indication to the scheduling server. The node scheduling indication indicates the scheduling server to schedule the second training node from the available training nodes and wake up the second training node. The first training node encodes the target training snapshot stored in the mount abstraction layer of the first training node to obtain the continuous memory space, configures the network parameters of the first memory service container via the first memory service container in the first training node, and performs the security verification on the target training snapshot. After the verification passes, the continuous memory space is sent to the second memory service container based on the configured network parameters. In response to an exception in the migrate process of the target training snapshot, the fifth indication information is sent to the fault tolerance platform, in which the fifth indication information indicates the fault tolerance platform to send the alarm message. Alternatively, the relevant information of the second training node in the mount abstraction layer may be cleared. That is, the first training node migrates the target training snapshot to the memory of the scheduled second training node. The second training node receives, via the second memory service container in the second training node, the continuous memory space sent by the first memory service container, and decodes the continuous memory space to obtain the target training snapshot. The second memory service container writes the target training snapshot into the mount abstraction layer of the second training node. The verification and directory recovery are performed on the target training snapshot. The snapshot state determination request is sent to the fault tolerance platform and the loading indication information sent by the fault tolerance platform is received. In response to the loading indication information indicating the second training node to load the available training snapshot from the remote storage cluster, the second training node accesses the remote storage cluster to obtain the available training snapshot from the remote storage cluster for the training recovery. In response to the loading indication information indicating the second training node to load the available training snapshot from the mount abstraction layer, the available training snapshot is loaded from the mount abstraction layer for the training recovery.

In conclusion, according to the model training snapshot migrate method in the embodiments of the disclosure, the migrate time of the model training snapshot is shortened, the migrate cost of the model training snapshot is reduced, the migrate efficiency of the model training snapshot is significantly improved, the interruption time of the model training is reduced, and an effective model training time is improved, which is conductive to improving a model training efficiency.

In the technical solutions of the disclosure, acquisition, storage and application of personal information of users are all in compliance with the provisions of relevant laws and regulations, and do not violate public order and good customs.

Corresponding to the model training snapshot backup method provided in the above embodiments, an embodiment of the disclosure also provides a model training snapshot backup apparatus. Since the model training snapshot backup apparatus provided in the embodiment corresponds to the model training snapshot backup method provided in the above embodiments, the implementation of the model training snapshot backup method is also applicable to the model training snapshot backup apparatus provided in the embodiment, and will not be described in detail in the embodiment.

FIG. 7 is a schematic diagram of a model training snapshot backup apparatus according to an embodiment of the disclosure.

As illustrated in FIG. 7, the model training snapshot backup apparatus 700 is applied to a first training node, and includes: an obtaining module 710, a determining module 720 and a backup module 730.

The obtaining module 710 is configured to obtain dynamic parameters to be backed up of a current training step of the model.

The determining module 720 is configured to determine a training snapshot of the current training step according to the dynamic parameters to be backed up.

The backup module 730 is configured to back up the training snapshot to a memory of the first training node.

The backup module 730 is further configured to: determine a target backup process corresponding to the current training step; and back up the training snapshot to the memory of the first training node by executing the target backup process, in which the target backup process is either a first backup process or a second backup process.

In a case that the target backup process is the first backup process, the backup module 730 is further configured to: obtain a first training snapshot by performing a single backup for the dynamic parameters to be backed up; and write the first training snapshot to a mount abstraction layer of the first training node.

In a case that the target backup process is the second backup process, the backup module 730 is further configured to: obtain a first training snapshot and a second training snapshot by performing a duple backup for the dynamic parameters to be backed up; write the first training snapshot to a mount abstraction layer of the first training node; and write the second training snapshot to a remote storage cluster via a persistence medium of the first training node.

The apparatus 700 is further configured to: perform an exception monitoring on each step of the first backup process, and in response to a failure of one of steps, send first indication information to a fault tolerance platform, in which the first indication information indicates the fault tolerance platform to perform at least one of the following operations: labeling the first backup process of the current training step of the model as failed; or sending a first alarm message.

The apparatus 700 is further configured to: perform an exception monitoring on each step of the second backup process, and in response to a failure of one of steps, perform at least one of the following operations: exiting a training process; or sending second indication information to a fault tolerance platform, in which the second indication information indicates the fault tolerance platform to send a second alarm message.

After writing the first training snapshot to the mount abstraction layer of the first training node, the apparatus 700 is further configured to: send third indication information to a fault tolerance platform, in which the third indication information indicates the fault tolerance platform to perform at least one of the following operations: updating a first backup list corresponding to the first backup process; or clearing an expired first training snapshot and a second training snapshot corresponding to the expired first training snapshot.

After writing the second training snapshot to the remote storage cluster, the apparatus 700 is further configured to: send fourth indication information to a fault tolerance platform, in which the fourth indication information indicates the fault tolerance platform to perform at least one of the following operations: updating a second backup list corresponding to the second backup process; storing the second backup list to a remote server; or clearing an expired first training snapshot and a second training snapshot corresponding to the expired first training snapshot.

According to the model training snapshot backup apparatus in the embodiment of the disclosure, the dynamic parameters to be backed up of the current training step of the model are obtained, so that the training snapshot of the current training step can be determined according to the dynamic parameters and backed up to the memory of the first training node. Therefore, by backing up the training snapshot to the memory of the first training node, the present disclosure can avoid affecting training performances, and enable the most efficient recovery when a fault occurs in a model training node, shorten training interruption time, significantly reduce the repeated calculation overhead, and improve a model training efficiency.

Corresponding to the model training snapshot migrate method provided in the above embodiments, an embodiment of the disclosure also provides a model training snapshot migrate apparatus. Since the model training snapshot migrate apparatus provided in the embodiment corresponds to the model training snapshot migrate method provided in the above embodiments, implementations of the model training snapshot migrate method are also applicable to the model training snapshot migrate apparatus provided in the embodiments of the disclosure, and will not be described in detail in the embodiments.

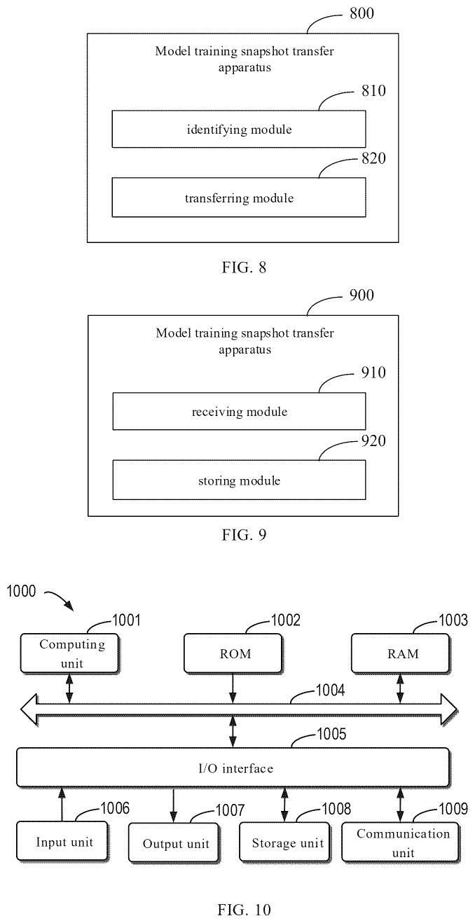

FIG. 8 is a schematic diagram of a model training snapshot migrate apparatus 800 according to an embodiment of the disclosure.

As illustrated in FIG. 8, the model training snapshot migrate apparatus 800 is applied to a first training node, and includes: an identifying module 810 and a migrating module 820.

The identifying module 810 is configured to, in response to identifying a fault in the first training node, determine a target training snapshot to be migrated in a memory of the first training node.

The migrating module 820 is configured to migrate the target training snapshot to a memory of a scheduled second training node.

The migrating module 820 is further configured to: migrate the target training snapshot stored in a mount abstraction layer of the first training node to a mount abstraction layer of the second training node via a memory service container.

The migrating module 820 is further configured to: encode the target training snapshot stored in the mount abstraction layer to obtain a continuous memory space; and send the continuous memory space to a second memory service container in the second training node via a first memory service container in the first training node.

The migrating module 820 is further configured to: configure network parameters for the first memory service container, and perform security verification on the target training snapshot; and send, based on the configured network parameters, the continuous memory space to the second memory service container in a case where the security verification passes.

The apparatus 800 is further configured to: in response to identifying a fault in the first training node, send an exception indication to a fault tolerance platform; in which the exception indication indicates the fault tolerance platform to send a node scheduling indication to a scheduling server, and the node scheduling indication indicates the scheduling server to schedule the second training node from available training nodes and wake up the second training node.

The apparatus 800 is further configured to: monitor a migrate process of the target training snapshot, and in response to an exception, send fifth indication information to a fault tolerance platform, in which the fifth indication information indicates the fault tolerance platform to send an alarm message.

The apparatus 800 is further configured to: monitor a migrate process of the target training snapshot, and in response to an exception, clear relevant information of the second training node in the mount abstraction layer of the second training node.

According to the model training snapshot migrate apparatus of the embodiment of the disclosure, in response to identifying a fault in the first training node, the target training snapshot to be migrated in the memory of the first training node is determined and migrated to the memory of the scheduled second training node. Therefore, the disclosure shortens a migrate time of the model training snapshot, reduces a migrate cost of the model training snapshot, significantly improves a migrate efficiency of the model training snapshot, and reduces an interruption time of model training, thus improving a model training efficiency.

Corresponding to the model training snapshot migrate method provided in the above embodiments, an embodiment of the disclosure also provides a model training snapshot migrate apparatus. Since the model training snapshot migrate apparatus provided in the embodiments of the disclosure corresponds to the model training snapshot migrate method provided in the above embodiments, the implementations of the model training snapshot migrate method are also applicable to the model training snapshot migrate apparatus provided in the embodiments of the disclosure, and will not be described in detail in the embodiments.

FIG. 9 is a schematic diagram of a model training snapshot migrate apparatus 900 according to an embodiment of the disclosure.

As illustrated in FIG. 9, the model training snapshot migrate apparatus 900 is applied to a second training node, and includes: a receiving module 910 and a storing module 920.

The receiving module 910 is configured to receive a target training snapshot migrated from a failed first training node, in which the target training snapshot is stored in a memory of the first training node.

The storing module 920 is configured to store the target training snapshot in a memory of the second training node.

The apparatus 900 is further configured to: receive, via a second memory service container in the second training node, the target training snapshot sent by a first memory service container of the first training node; and write the target training snapshot to a mount abstraction layer of the second training node via the second memory service container.

The apparatus 900 is further configured to: receive, via the second memory service container in the second training node, a continuous memory space sent by the first memory service container, and decode the continuous memory space to obtain the target training snapshot; in which the continuous memory space is obtained by encoding the target training snapshot by the first memory service container.

The apparatus 900 is further configured to: perform verification and directory recovery on the target training snapshot.

After performing the verification and directory recovery on the target training snapshot, the apparatus 900 is further configured to: send a snapshot state awareness request to a fault tolerance platform, in which the snapshot state awareness request is used to request the fault tolerance platform to determine whether there is an available training snapshot in the target training snapshot; receive loading indication information sent by the fault tolerance platform; and load, according to the loading indication information, the available training snapshot for training recovery.

The apparatus 900 is further configured to: in response to the loading indication information indicating the second training node to load the available training snapshot from a remote storage cluster, access the remote storage cluster and obtain the available training snapshot from the remote storage cluster for training recovery; and in response to the loading indication information indicating the second training node to load the available training snapshot from the mount abstraction layer, load the available training snapshot from the mount abstraction layer for training recovery.

According to the model training snapshot migrate apparatus in the embodiment of the disclosure, the target training snapshot migrated from the failed first training node is received, in which the target training snapshot is stored in the memory of the first training node, and then the target training snapshot is stored in the memory of the second training node. Therefore, the disclosure shortens a migrate time of the model training snapshot, reduces a migrate cost of the model training snapshot, significantly improves a migrate efficiency of the model training snapshot, and reduces an interruption time of model training, thus improving a model training efficiency.

According to the embodiments of the disclosure, the disclosure also provides an electronic device, a readable storage medium and a computer program product.

FIG. 10 is a schematic block diagram of an example electronic device 1000 that can be used to implement the embodiments of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown here, their connections and relations, and their functions are merely examples, and are not intended to limit the implementation of the disclosure described and/or required herein.

As illustrated in FIG. 10, the device 1000 includes: a computing unit 1001 for performing various appropriate actions and processes according to computer programs stored in a Read-Only Memory (ROM) 1002 or computer programs loaded from a storage unit 1008 to a Random Access Memory (RAM) 1003. The RAM 1003 may also stores necessary programs and data for the device 1000 to operate. The computing unit 1001, the ROM 1002 and the RAM 1003 are connected to each other via a bus 1004. An input/output (I/O) interface 1005 is also connected to the bus 1004.

Components in the device 1000 are connected to the I/O interface 1005, including: an input unit 1006, such as a keyboard and a mouse; an output unit 1007, such as various types of displays and speakers; the storage unit 1008, such as a disk and an optical disk; and a communication unit 1009, such as a network card, a modem and a wireless communication transceiver. The communication unit 1009 allows the device 1000 to exchange information/data with other devices via a computer network such as the Internet and/or various telecommunication networks.

The computing unit 1001 may be various general-purpose and/or dedicated processing components having processing and computing capabilities. Some examples of the computing unit 1001 include, but are not limited to, a CPU, a Graphics Processing Unit (GPU), various dedicated AI computing chips, various computing units that run ML model algorithms, a Digital Signal Processor (DSP) and any appropriate processor, controller or microcontroller. The computing unit 1001 executes the various methods and processes described above, such as the model training snapshot backup method or the model training snapshot migrate method. For example, in some embodiments, the above methods may be implemented as a computer software program, which is tangibly contained in a machine readable medium, such as the storage unit 1008. In some embodiments, part or all of the computer programs may be loaded and/or installed on the device 1000 via the ROM 1002 and/or the communication unit 1009. When the computer programs are loaded on the RAM 1003 and executed by the computing unit 1001, one or more steps of the above method may be executed. Alternatively, in other embodiments, the computing unit 1001 may be configured to perform the above model training snapshot backup method or the model training snapshot migrate method in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware/firmware/software, and/or any combination thereof. These implementations may be implemented in one or more computer programs, the one or more computer programs may be executed and/or interpreted on a programmable system including at least one programmable processor, which may be a dedicated or general programmable processor for receiving data and instructions from a storage system, at least one input apparatus and at least one output apparatus e, and transmitting data and instructions to the storage system, the at least one input apparatus and the at least one output apparatus.

The program codes configured to implement the method of the disclosure may be written in any combination of one or more programming languages. These program codes may be provided to a processor/controller of a general-purpose computer, a dedicated computer or any other programmable data processing apparatus, so that when the program codes are executed by the processor/controller, the functions/operations specified in the flowchart and/or block diagram can be implemented. The program codes may be executed entirely on the machine, partly executed on the machine, partly executed on the machine and partly executed on the remote machine as an independent software package, or entirely executed on the remote machine or server.

In the context of the disclosure, a machine readable medium may be a tangible medium that may contain or store a program for use by or in combination with an instruction execution system, an apparatus, or a device. The machine readable medium may be a machine readable signal medium or a machine readable storage medium. The machine readable medium may include, but is not limited to, an electronic, magnetic, optical, electromagnetic, infrared, or semiconductor system/apparatus/device, or any suitable combination of the above. More specific examples of the machine readable storage medium include electrical connections based on one or more wires, portable computer disks, hard disks, RAMs, ROMs, Electrically Programmable Read-Only-Memories (EPROMs) or flash memories, fiber optics, Compact Disc Read-Only Memories (CD-ROMs), optical storage devices, magnetic storage devices, or any suitable combination of the foregoing.

In order to provide interaction with a user, the systems and techniques described herein may be implemented on a computer having a display apparatus (e.g., a Cathode Ray Tube (CRT) or a Liquid Crystal Display (LCD) monitor) for displaying information to a user; and a keyboard and a pointing apparatus (such as a mouse or trackball) via which the user can provide input to the computer. Other kinds of apparatuses may also be used to provide interaction with the user. For example, the feedback provided to the user may be any form of sensory feedback (e.g., visual feedback, auditory feedback or haptic feedback), and the input from the user may be received in any form (including acoustic input, voice input or tactile input).

The systems and technologies described herein can be implemented in a computing system that includes back-end components (for example, a data server), or a computing system that includes middleware components (for example, an application server), or a computing system that includes front-end components (for example, a user computer with a graphical user interface or a web browser, via which the user can interact with the implementations of the systems and technologies described herein), or a computing system that includes any combination of such back-end components, middleware components and front-end components. The components of the system may be interconnected by any form or medium of digital data communication (e.g., a communication network). The communication network may include, for example, a Local Area Network (LAN), a Wide Area Network (WAN), the Internet and a block-chain network.

The computer system may include a client and a server. The client and the server are generally remote from each other and interacting via a communication network. The client-server relation is generated by computer programs running on the respective computers and having a client-server relation with each other. The server may be a cloud server, a server with a distributed system, or a server combined with a block-chain.

The disclosure also provides a computer program product including a computer program. When the computer program is executed by a processor, the steps of the model training snapshot backup method or the model training snapshot migrate method described in the above embodiments of the disclosure are implemented.

It is understandable that the steps can be reordered, added or deleted using various forms of the processes shown above. For example, the steps in the disclosure may be performed in parallel or sequentially or in different orders, as long as the desired results of the technical solutions disclosed in the disclosure are achieved, which is not limited herein.

The specific implementations described above do not constitute a limitation on the scope of protection of the disclosure. It should be understood by those skilled in the art that various modifications, combinations, sub-combinations and substitutions can be made depending on design requirements and other factors. Any modifications, equivalent substitutions and improvements made within the spirit and principles of the disclosure shall be included in the scope of protection of the disclosure.

What is claimed is:

1. A model training snapshot backup method, performed by a first training node, comprising:
obtaining dynamic parameters to be backed up of a current training step of a model;
determining a training snapshot of the current training step according to the dynamic parameters to be backed up; and
backing up the training snapshot to a memory of the first training node.

2. The method of claim 1, further comprising:
determining a target backup process corresponding to the current training step; and
backing up the training snapshot to the memory of the first training node by executing the target backup process, wherein the target backup process is either a first backup process or a second backup process.

3. The method of claim 2, wherein in a case that the target backup process is the first backup process, the method further comprises:
obtaining a first training snapshot by performing a single backup for the dynamic parameters to be backed up; and
writing the first training snapshot to a mount abstraction layer of the first training node.

4. The method of claim 2, wherein in a case that the target backup process is the second backup process, the method further comprises:
obtaining a first training snapshot and a second training snapshot by performing a duple backup for the dynamic parameters to be backed up;
writing the first training snapshot to a mount abstraction layer of the first training node; and
writing the second training snapshot to a remote storage cluster via a persistence medium of the first training node.

5. The method of claim 3, further comprising:
performing an exception monitoring on each step of the first backup process, and in response to a failure of one of steps, sending first indication information to a fault tolerance platform, wherein the first indication information indicates the fault tolerance platform to perform at least one of the following operations:
labeling the first backup process of the current raining step of the model as failed; or
sending a first alarm message;
optionally, the method further comprising:
performing an exception monitoring on each step of the second backup process, and in response to a failure of one of steps, performing at least one of the following operations:
exiting a training process; or
sending second indication information to a fault tolerance platform, wherein the second indication information indicates the fault tolerance platform to send a second alarm message.

6. The method of claim 3, wherein after writing the first training snapshot to the mount abstraction layer of the first training node, the method further comprises:
sending third indication information to a fault tolerance platform, wherein the third indication information indicates the fault tolerance platform to perform at least one of the following operations:
updating a first backup list corresponding to the first backup process; or
clearing an expired first training snapshot and a second training snapshot corresponding to the expired first training snapshot.

7. The method of claim 4, wherein after writing the second training snapshot to the remote storage cluster, the method further comprises:
sending fourth indication information to a fault tolerance platform, wherein the fourth indication information indicates the fault tolerance platform to perform at least one of the following operations:
updating a second backup list corresponding to the second backup process;
storing the second backup list to a remote server; or
clearing an expired first training snapshot and a second training snapshot corresponding to the expired first training snapshot.

8. A model training snapshot migrate method, performed by a first training node, comprising:
in response to identifying a fault in the first training node, determining a target training snapshot to be migrated in a memory of the first training node; and
migrating the target training snapshot to a memory of a scheduled second training node.

9. The method of claim 8, wherein migrating the target training snapshot to the memory of the scheduled second training node, comprises:
migrating the target training snapshot stored in a mount abstraction layer of the first training node to a mount abstraction layer of the second training node via a memory service container;
optionally, wherein migrating the target training snapshot stored in the mount abstraction layer of the first training node to the mount abstraction layer of the second training node via the memory service container, comprises:
encoding the target training snapshot stored in the mount abstraction layer of the first training node to obtain a continuous memory space; and
sending the continuous memory space to a second memory service container in the second training node via a first memory service container in the first training node;
optionally, wherein sending the continuous memory space to the second memory service container in the second training node via the first memory service container in the first training node, comprises:
configuring network parameters for the first memory service container, and performing a security verification on the target training snapshot; and
sending, based on the configured network parameters, the continuous memory space to the second memory service container in a case where the security verification passes.

10. The method of claim 8, further comprising:
in response to identifying a fault in the first training node, sending an exception indication to a fault tolerance platform;
wherein the exception indication indicates the fault tolerance platform to send a node scheduling indication to a scheduling server, and the node scheduling indication indicates the scheduling server to schedule the second training node from available training nodes and wake up the second training node.

11. The method of claim 8, further comprising:
monitoring a migrate process of the target training snapshot, and in response to an exception, sending fifth indication information to a fault tolerance platform, wherein the fifth indication information indicates the fault tolerance platform to send an alarm message.

12. The method of claim 9, further comprising:
monitoring a migrate process of the target training snapshot, and in response to an exception, clearing relevant information of the second training node in the mount abstraction layer of the second training node.

13. A model training snapshot migrate method, performed by a second training node, comprising:
receiving a target training snapshot migrated from a failed first training node, wherein the target training snapshot is stored in a memory of the first training node; and
storing the target training snapshot in a memory of the second training node.

14. The method of claim 13, further comprising:
receiving, via a second memory service container in the second training node, the target training snapshot sent by a first memory service container of the first training node; and
writing the target training snapshot to a mount abstraction layer of the second training node via the second memory service container.

15. The method of claim 14, further comprising:
receiving, via the second memory service container in the second training node, a continuous memory space sent by the first memory service container, and decoding the continuous memory space to obtain the target training snapshot;
wherein the continuous memory space is obtained by encoding the target training snapshot by the first memory service container.

16. The method of claim 15, further comprising:
performing verification and directory recovery on the target training snapshot;
optionally, wherein after performing the verification and directory recovery on the target training snapshot, the method further comprises:
sending a snapshot state awareness request to a fault tolerance platform, wherein the snapshot state awareness request is used to request the fault tolerance platform to determine whether there is an available training snapshot in the target training snapshot;
receiving loading indication information sent by the fault tolerance platform; and
loading, according to the loading indication information, the available training snapshot for training recovery;
optionally, wherein loading, according to the loading indication information, the available training snapshot for training recovery, comprises:
in response to the loading indication information indicating the second training node to load the available training snapshot from a remote storage cluster, accessing the remote storage cluster and obtaining the available training snapshot from the remote storage cluster for the training recovery; and
in response to the loading indication information indicating the second training node to load the available training snapshot from the mount abstraction layer, loading the available training snapshot from the mount abstraction layer for the training recovery.

17. An electronic device, comprising a processor and a memory;
wherein when the processor runs a program corresponding to an executable program code by reading the executable program code stored in the memory, the method according to claim 1 is implemented.

18. An electronic device, comprising a processor and a memory;
wherein when the processor runs a program corresponding to an executable program code by reading the executable program code stored in the memory, the method according to claim 8 is implemented.

19. An electronic device, comprising a processor and a memory;
wherein when the processor runs a program corresponding to an executable program code by reading the executable program code stored in the memory, the method according to claim 13 is implemented.

20. A computer readable storage medium having a computer program stored thereon, wherein when the program is executed by a processor, the method according to claim 1 is implemented.
